(19) United States
(12) Patent Application Publication
(10) Pub. No.: US 2026/0084318 A1
(43) Pub. Date: Mar. 26, 2026

(54) SYSTEM OF EQUIPMENT FOR CREATING ARTWORKS USING A ROBOT ARTIST

(71) Applicants: Nikolai Pavlovich Gavrilin, Korolev (RU); Anna Victorovna Mishchenko, Korolev (RU)

(72) Inventors: Nikolai Pavlovich Gavrilin, Korolev (RU); Anna Victorovna Mishchenko, Korolev (RU)

(21) Appl. No.: 18/895,079

(22) Filed: Sep. 24, 2024

(51) Int. Cl. B25J 11/00; A46B 17/02; A46B 17/06; B25J 15/04; B44D 3/02

(52) U.S. Cl. CPC B25J 11/0075; A46B 17/02; A46B 17/06; B25J 15/0441; B25J 15/0491; B44D 3/02; A46B 2200/205

(57) ABSTRACT

A system of equipment for creating artworks using a robot artist having a robotic arm. The system generally includes a gripper removably installed in the robotic arm, a magnetic brush clamp supporting a painting brush, and a brush stand with multiple compartments. The gripper includes a first magnetic material, and the magnetic brush clamp has a second magnetic material selected to removably attract to the first magnetic material of the gripper so as to removably attach the magnetic brush clamp with the painting brush to the gripper. Each compartment of the brush stand is sized and configured to removably receive the magnetic brush clamp with the painting brush therein. Relative positions and inclination angles between the gripper, the magnetic brush clamp and the brush stand are calibrated for optimal painting conditions for the robot artist.

### CROSS-REFERENCE TO RELATED APPLICATIONS

This Application is related to and claims all rights of priority to U.S. Design Ser. No. 29/943,902 filed on May 24, 2024 (pending).

### BACKGROUND

The invention relates to the intersection of the fields of robotics and art, in particular to automated drawing systems. The invention can be used in the field of robotics, art and design, as well as for educational and scientific purposes to study and demonstrate the principles of robotic drawing.

Existing solutions in the field of robotic drawing are mostly based on the use of a gripper in the form of a gripper that imitates a human hand or grip. However, this approach has a number of disadvantages. Firstly, the complexity of the design, which leads to increased cost and complexity of maintenance. Secondly, it is unreliable, since mechanical elements are subject to wear and require regular replacement.

In contrast, the proposed invention uses a magnetic gripper. This greatly simplifies the design, makes it more reliable and durable, and also reduces the cost of production and maintenance. In addition, this approach allows for more precise control over the drawing process, since the magnetic mount provides a more stable and secure attachment of the hand, at least compared to some types of grip designs.

### SUMMARY

The invention is an integrated set of equipment that includes all the necessary components for drawing by a robot artist. The purpose of the invention is to provide the possibility, convenience and accuracy of the drawing process, as well as to simplify and automate the process of replacing and processing art brushes. The essence of the invention is to create a set of equipment for drawing by a robot artist. This set is a combination of technical solutions that provide the ability, convenience and automation of the drawing process, as well as simplify and make the equipment calibration process more convenient.

One of the key features of the invention is the integration of various components into a single system, which allows the robot artist to have all the necessary tools at hand. In its general embodiment, the system includes a gripper removably installed in the robotic arm, a magnetic brush clamp supporting a painting brush, and a brush stand with multiple compartments. The gripper includes a first magnetic material, and the magnetic brush clamp has a second magnetic material selected to removably attract to the first magnetic material of the gripper so as to removably attach the magnetic brush clamp with the painting brush to the gripper. Each compartment of the brush stand is sized and configured to removably receive the magnetic brush clamp with the painting brush therein. Relative positions and inclination angles between the gripper, the magnetic brush clamp and the brush stand are calibrated for optimal painting conditions for the robot artist.

The system can also include a wiping system for cleaning the brush from paint, a palette for mixing paints and other additional tools for setting up and optimizing the painting process. The invention also provides the possibility of both manual and automatic changing of brushes, which allows the robot to use different types of brushes during the drawing process.

The invention is a unique set of equipment that provides automation of the painting process by a robot artist, including the replacement and installation of art brushes, the preparation of paints and the installation of canvas. The novelty of the invention lies in the integration of all components necessary for preparation for drawing and the drawing itself into a single system, which ensures the convenience and efficiency of the drawing process.

### BRIEF DESCRIPTION OF THE DRAWINGS

FIG. 1 shows a basic universal equipment system for drawing using a robot artist, in accordance with the preferred embodiment of the invention;

FIG. 2 shows a more complex universal equipment system with a vertical easel, in accordance with the preferred embodiment of the invention;

FIG. 3 shows a more complex universal equipment system with a horizontal easel, in accordance with the preferred embodiment of the invention;

FIG. 4 shows a front perspective view of the gripper;

FIG. 5 shows a rear perspective view of the gripper;

FIG. 6 shows the gripper coupled to the brush clamp;

FIG. 7 shows the gripper coupled to the brush clamp with a brush installed in the clamp;

FIG. 8 shows a bracket base;

FIG. 9 shows an intermediate bracket;

FIG. 10 shows a brush clamp adapter;

FIG. 11 shows a magnetic brush clamp with the brush installed;

FIG. 12 shows a base of the brush clamp;

FIG. 13 shows a bracket of the brush clamp;

FIG. 14 shows a brush holder with a clamp;

FIG. 15 shows a brush clamp with tilt adjustment;

FIG. 16 shows a base of the adjustable brush clamp;

FIG. 17 shows a movable part of the adjustable hand clamp;

FIG. 18 shows a general perspective view of the brush base;

FIG. 19 shows a general perspective view of the brush base with brush clamps with brushes installed in slots;

FIG. 20 shows a mounting plate of the brush base stand;

FIG. 21 shows an intermediate bracket for the brush base;

FIG. 22 shows a slot-brush adapter holder for brush base;

FIG. 23 shows a brush base profile adapter;

FIG. 24 shows a profile of the base of the brush base;

FIG. 25 shows a general perspective view of the palette-base and jars;

FIG. 26 shows a wiping system-general view in projection;

FIG. 27 shows a large cleaning container;

FIG. 28 shows a small cleaning container;

FIG. 29 shows the brush gauge/meter;

FIG. 30 show the brush gauge/meter with installed brush clamp and brush;

FIG. 31 shows a calibration tool for installing the brush;

FIG. 32 show a calibration docking station;

FIG. 33 shows a calibration docking station lock;

FIG. 34 shows a gripper angle;

FIG. 35 shows a front view of the gripper angle when calibrating the gripper;

FIG. 36 shows a brush stand angle;

FIG. 37 sows the brush stand angle when calibrating the brush base;

FIG. 38 shows a magnetic damper;

FIG. 38 shows a magnetic damper;

FIG. 39 shows the magnetic damper installed on the brush base to calibrate it with the gripper-general view in projection;

FIG. 41 shows a damper head;

FIG. 42 shows a brush clip;

FIG. 43 shows a brush clip with a connected brush clamp with a brush;

FIG. 44 shows a fixed grip;

FIG. 45 shows a pressing lever;

FIG. 46 shows a corner calibrator for computer vision;

FIG. 47 shows a corner calibrator for computer vision with a mark applied;

FIG. 48 shows a modular vertical easel;

FIG. 49 shows a vertical stop;

FIG. 50 shows a horizontal stop;

FIG. 51 shows a link F-F;

FIG. 52 shows a link M-F;

FIG. 53 shows a reference angle; and

FIG. 54 shows a clamp handle

### DESCRIPTION

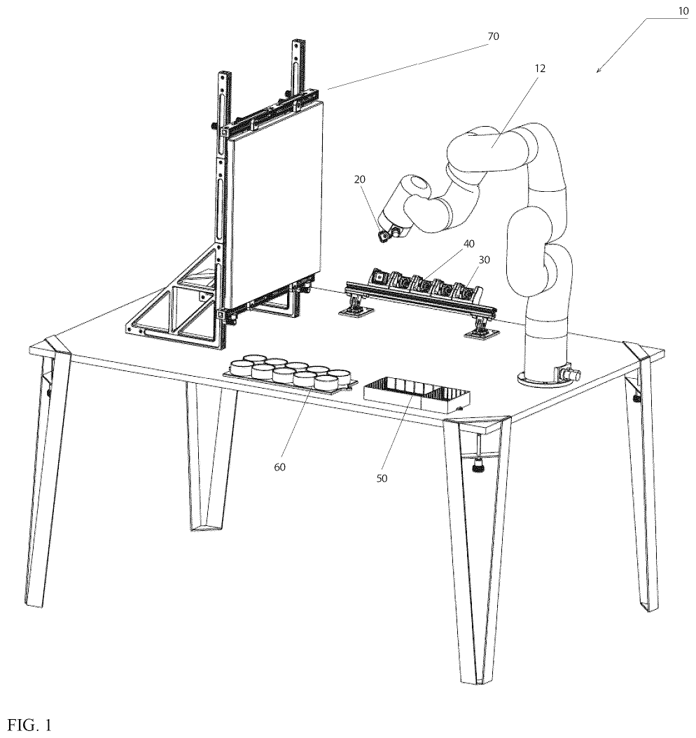

As shown in FIG. 1, in its basic embodiment, the universal equipment system 10 for drawing using a robot artist includes a gripper 20, a magnetic brush clamp 30 (shown in FIG. 1 without a brush), a brush stand 40, a brush washer 50, a palette 60, and a modular vertical easel 70.

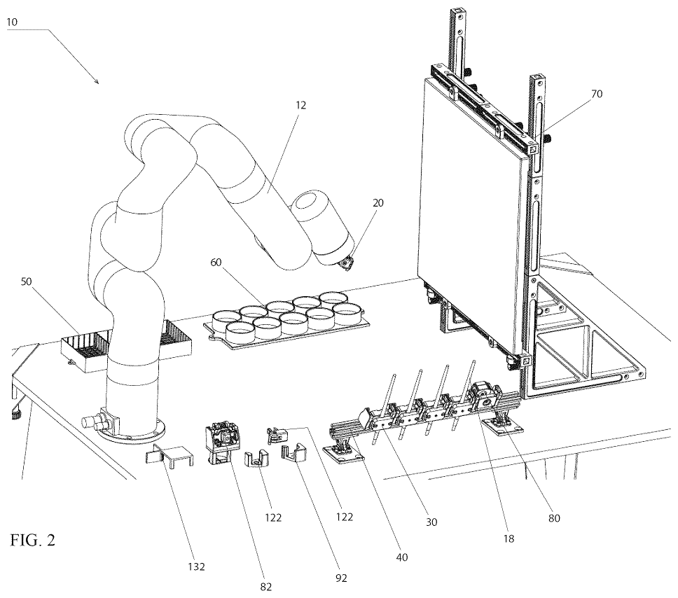

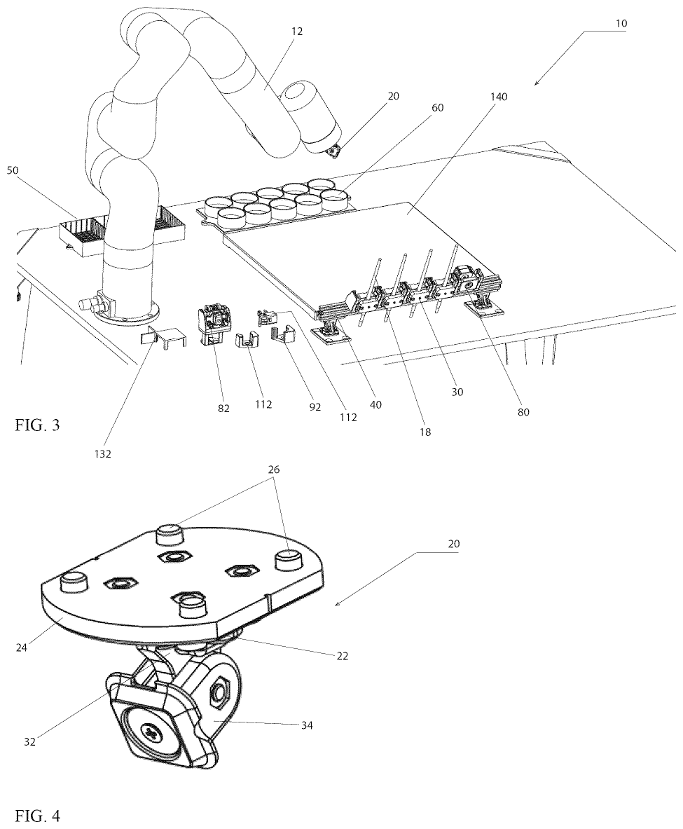

In a more complex embodiment, shown in FIGS. 2 and 3, system 10 preferably includes gripper 20, magnetic brush clamp 30 (installed in the brush stand 40), a magnetic damper 80 (also installed in the brush stand 40), brush stand 40, brush washer 50, palette 60, and either a modular vertical easel 70 (shown in FIG. 2) or a horizontally installed canvas 140 (shown in FIG. 3). Additionally, in this more complex embodiment, system 10 also includes a brush calibrating meter 82, a gripper angle 92, a brush stand calibrating angle 112, a brush clip 122, and a corner calibrator for computer vision 132.

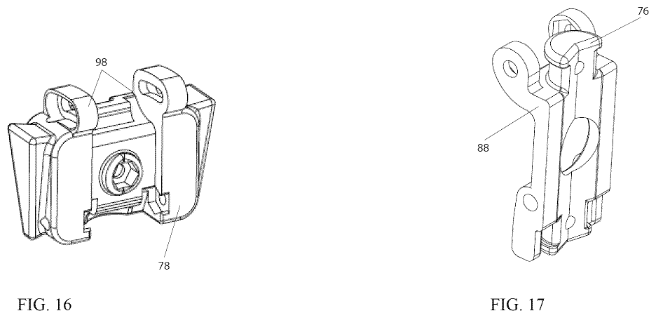

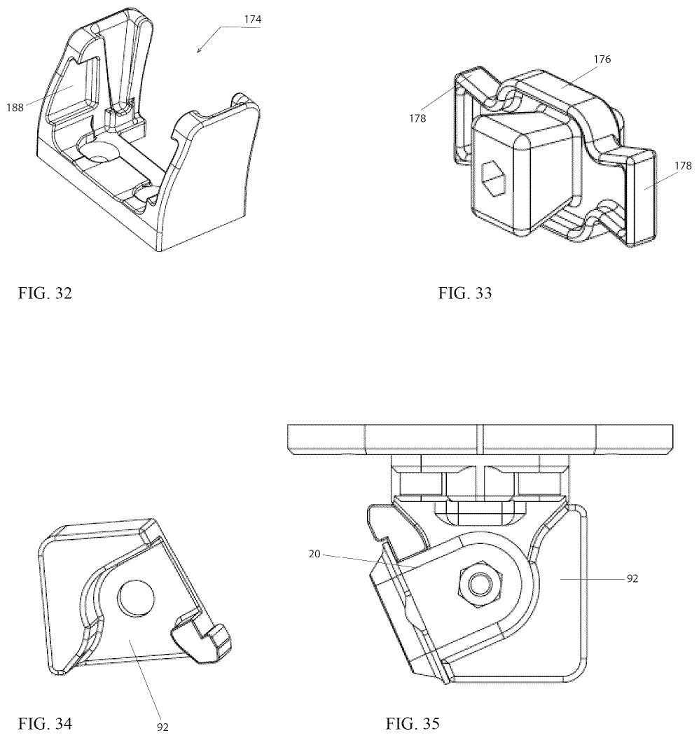

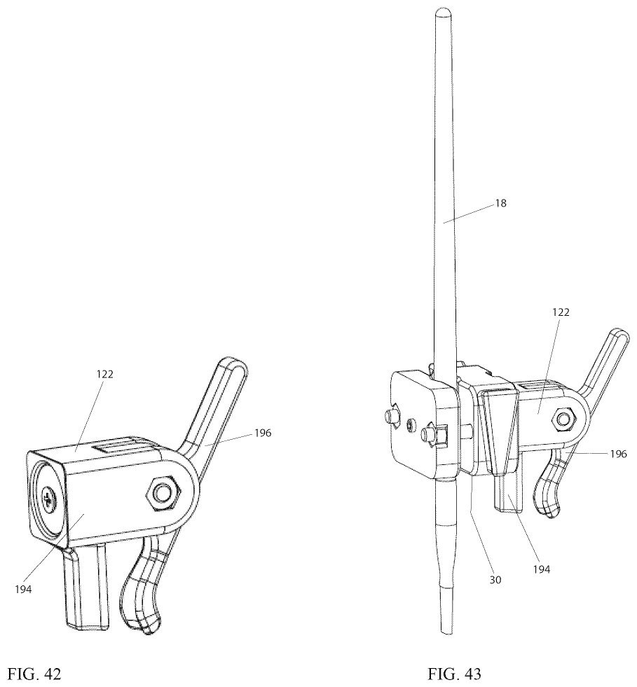

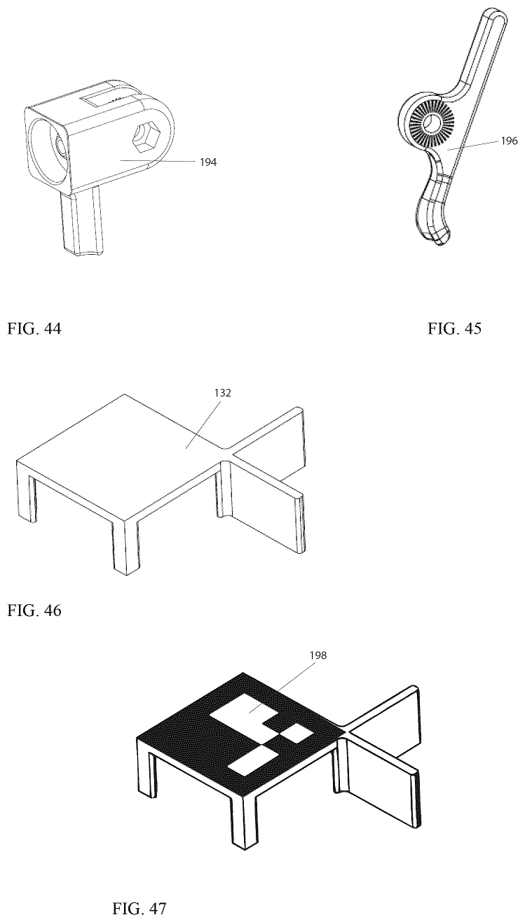

Individual components of the system 10 are shown in more detail in FIG. 4-54.

As shown in FIGS. 4-7, gripper 20 is a device configured to attach a drawing brush 18 to a robotic arm 12. The gripper is configured to work in conjunction with the magnetic brush clump 30, and is essentially a magnetic mount mounted at an angle on the working grip of the robotic arm.

A distinctive feature of the gripper 20 is its ability to provide stable attachment of the brush 18 to the robotic arm 12 at the angle required for drawing. The gripper design also allows for easy detachment of the drawing brush 18 and for changing to another brush, either manually or automatically. This avoids the use of complex and expensive electromechanical grippers while maintaining grip reliability.

The technical effect achieved with the help of the gripper 20 is to ensure precise and stable attachment of the brush 18 to the robotic arm 12 at the required angle, which, in turn, allows the robot artist to make more accurate and high-quality drawings. Also, this design allows the user to simply change the brush manually or automatically, using the brush stand 40.

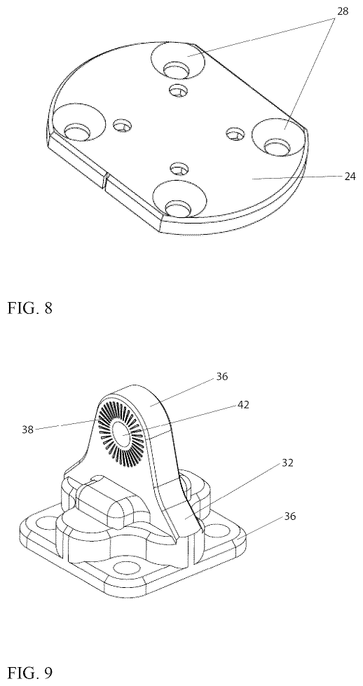

As shown in FIGS. 4-5 and 8-10, gripper 20 preferably includes a bracket assembly 22 having a base 24, an intermediate bracket 32 and a brush clamp adapter 34. Base 24, shown in detail in FIG. 8, is used to attach the entire bracket assembly 22 to the robot using screws 26 inserted into screw holes 28. Robots typically have multiple screw holes for attaching various devices. Such screw attachments are known in the art and will not be described herein in detail. To attach a gripper to a robot model that has a different configuration of mounting holes, a differently configured base 24 may be utilized, while the other parts of the gripper 20 remain unchanged.

The intermediate bracket 32, shown in FIG. 9, serves to position the brush clamp adapter 34 at the desired angle, i.e., the angle optimal for tilting the brush for applying strokes in an artistic style. It is at the same angle that the brush is attached to the gripper using the brush clamp adapter in any of the modifications described below. For various purposes, i.e., drawing techniques, position of the canvas relative to the robot, and so on, the angle of inclination of the brush can be different. Therefore, the intermediate bracket 32 and brush clamp adapter 34 are designed with the ability to rotate the latter relative to the former, and thus to change the angle of inclination of the brush.

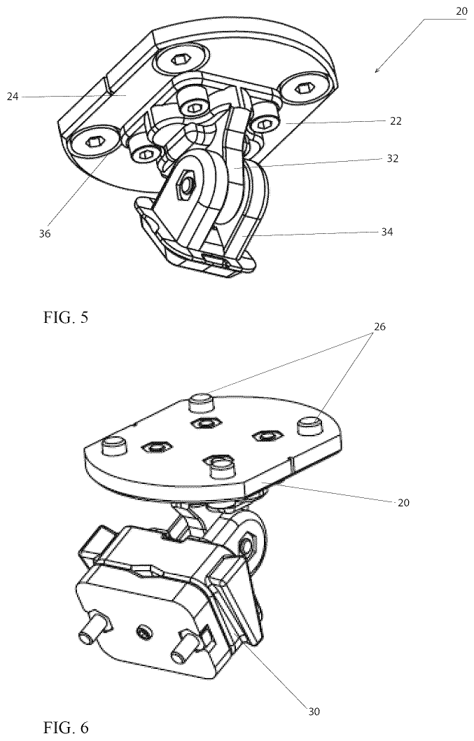

As shown in FIGS. 5 and 9, the intermediate bracket 32 preferably includes an intermediate base 36, designed to be fixedly attached to the bottom of the base 24 so as to fixedly secure the intermediate bracket 32 to the base 24. Intermediate bracket 32 further includes a rounded mounting portion 36 having a ridged positioning dial 38 on each side and a central aperture 42.

Brush clamp adapter 34, shown in FIG. 10, preferably includes two rounded supports 44, each having a through hole 46 and an internal ridged positioning dial 48. Holes 46 and dials 48 are configured to correspond to the aperture 42 and the positioning dial 38 of the intermediate bracket 32, so that, when the dials 48 are positioned on the dial 38 at a predetermined angle, and a screw (or any other known connector) is inserted through the through holes 46 and the aperture 42, the brush clamp adapter 34 is securely attached to the intermediate bracket 32 at the optimal desired angle for drawing. The resulting connection between the intermediate bracket 32 and the brush clamp adapter 34 is secure and, at the same time, allows for an easy detachment and re-attachment of any configuration of the magnetic brush clamp 30.

Brush clamp adapter 34 further has a built-in recess 52 to accommodate a magnet or a magnetic material, preferably in one of the standard commercially available sizes, for attachment to the magnetic brush clamp 30. The brush clamp adapter 34 also has an outer edge 54 configured to correspond with a magnet surrounding inner wall 56 of the magnetic brush clamp 30, which, in combination with the magnet, provides the required accuracy, reliability, and ease of manual or automatic attachment and detachment.

For the convenience of quick angle calibration in setting the required angle of the brush, gripper angle 92 can be used as part of the additional equipment. However, manual calibration is also possible.

As shown in FIG. 11, the magnetic brush clamp 30 is a device for gripping an artist's brush 18 and for temporarily but securely attaching it to the gripper 20 to accomplish painting/drawing. In its preferred embodiment, the magnetic brush clamp 30 generally includes an internal magnet for attaching to the gripper 20 and structural side protrusions for secure installation into the brush stand 40.

A distinctive feature of the magnetic brush clamp is its ability to provide stable fixation of the brush while the robot is painting. The design of the magnetic brush clamp allows its user to use different brushes during the drawing process and to change them manually or automatically using the brush stand.

The technical effect achieved using the magnetic brush clamp is providing a stable fixation of brushes (preferably brushes with a handle having a round or oval cross-section) while drawing; an easy exchange of brushes, i.e., detaching one magnetic brush clamp with its brush from the gripper and attaching another magnetic brush clamp with another brush to the gripper, the entire exchange process being done automatically using the brush stand or manually; and a possibility of storing the brushes on the brush stand during or outside of the painting process.

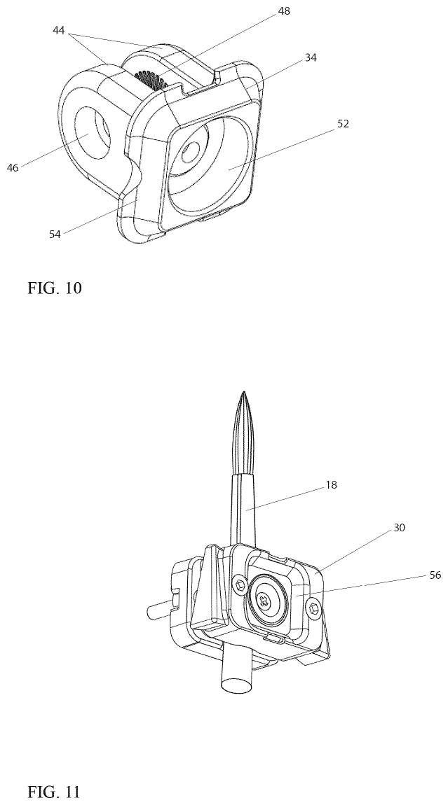

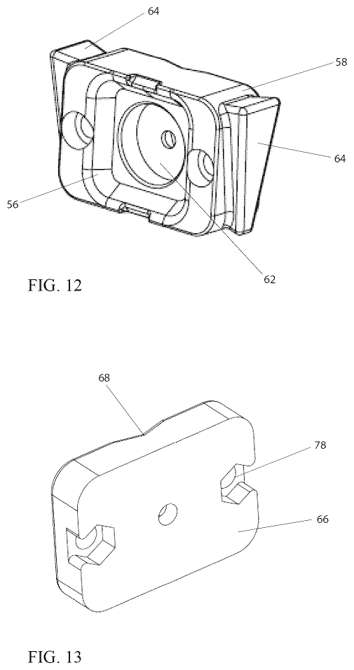

As shown in FIG. 12, the magnetic brush clamp preferably includes a magnetic base 58 which has a built-in recess 62 for mounting a magnet (not shown) or magnetic material, preferably in one of the standard commercially available sizes, for attachment to the magnet within the recess 52 of the brush clamp adapter 34 of the gripper 20. The inner wall 56 of the recess 62 preferably has beveled and/or rounded corners for a complementary connection with the outer edge 54 of the brush clamp adapter 34. This configuration, in combination with the dual magnets, provides the desired accuracy, reliability, technological simplicity, safety, and ease of manual and/or automatic attachment and detachment.

The reliability of this connection method lies in the fact that, according to the results of numerous experiments, a trouble-free drawing/painting process is ensured under normal operating conditions. In this case, for example, when an inexperienced user is working with the robot-artist, a situation may arise when the gripper-brush clamp assembly may collide, for example, with the canvas. Then, because of the inventive configuration of beveled and/or rounded corners, either the entire assembly returns to its connected state after the impact, or a complete undocking ensues (i.e., separation of the brush clamp from the gripper), which ensures safety of the user and all structural elements.

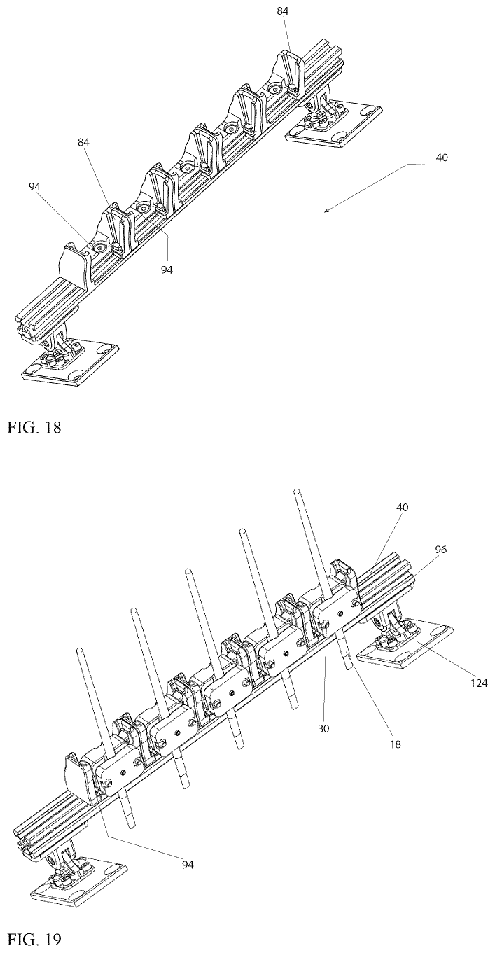

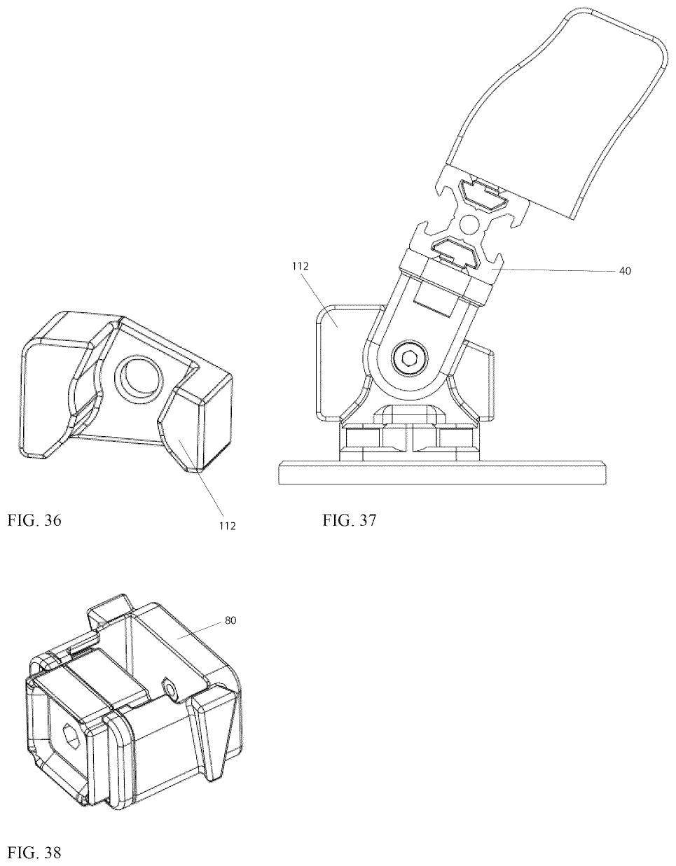

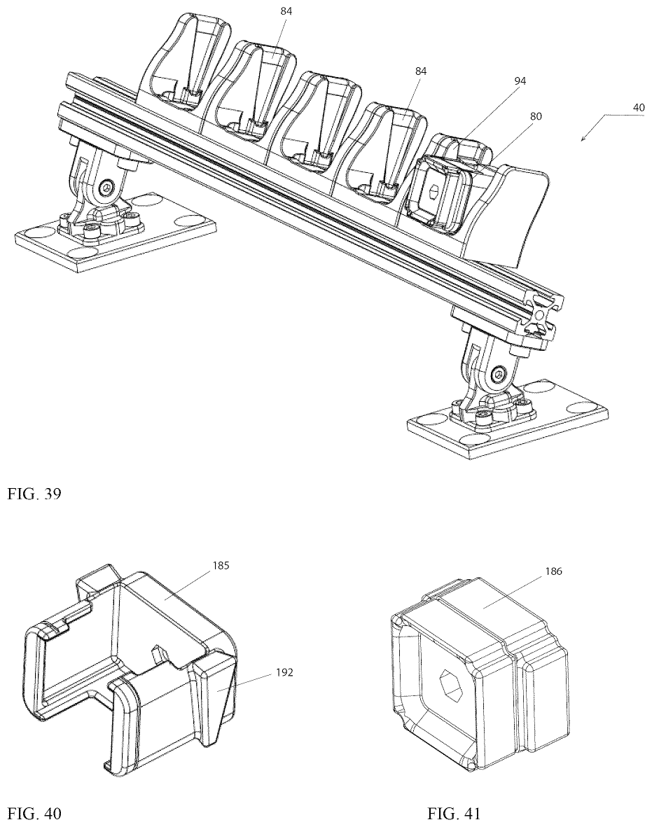

Magnetic base 58 of the magnetic brush clamp 30 also includes side protrusions 64 for safely positioning the magnetic brush clamp into the brush base 40. As described further below, side protrusions 64 are configured to be complementary to and to slidingly fit within side groves 84 (shown in more detail in FIGS. 18 and 39) to ensure an automatic pick-up and exchange of the brush and a convenient storage of brushes.

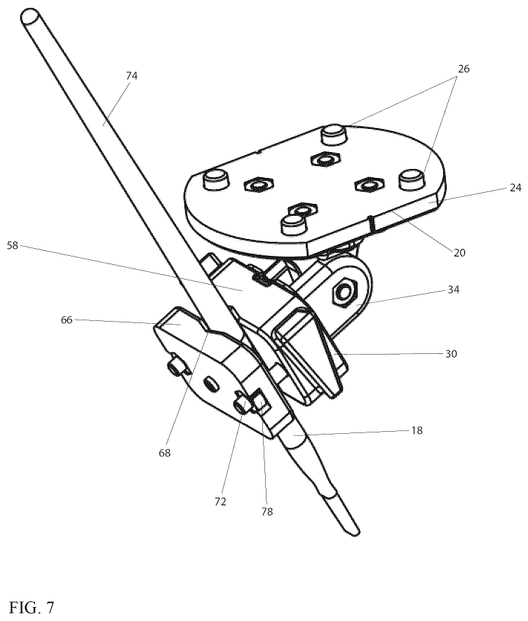

The magnetic brush clamp 30 further include a brush bracket 66, shown in FIG. 13. Brush bracket 66 serves to ensure a reliable and precise fixation of the brush in the magnetic brush clamp 30. The brush bracket preferably includes a brush recess 68 located on its side facing the brush extending from its top surface to its bottom surface, and sized to accommodate a portion of a handle 74 of the brush 18 along its length. Brush bracket 66 also preferably includes two screw holes 78 into which clamping screws 72 (shown in FIG. 7) can be inserted.

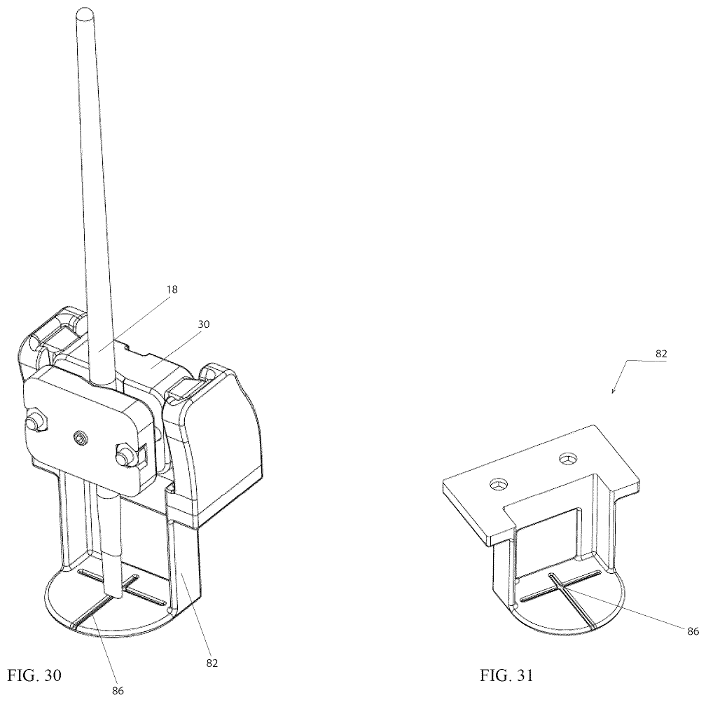

In use, a portion of the brush handle 74 is positioned along the recess 68 of the brush bracket 66, and the brush bracket is then secured to the magnetic base 58 using the clamping screws 72, as shown in FIG. 7. Reliability of this assembly is ensured by the clamping screws. Optionally, for some models of brushes, a handle made of low friction material, a gasket, such as rubber or glue, or other means of increasing the friction can also be utilized. Accuracy of the brush installation can be ensured by using the brush calibrating meter 82, as shown in FIG. 30. To performed the calibration, the magnetic brush clamp 30 with the installed brush 18 is inserted into the brush calibrating meter 82, and the brush's position is calibrated using the cross-notch target 86.

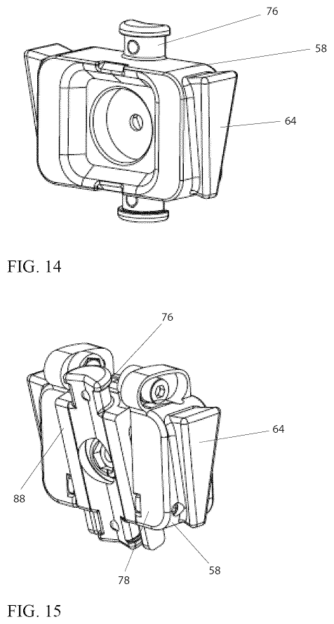

As shown in FIG. 14, to provide a more adaptable brush attachment, the magnetic base 58 can further include a brush holder 76 which has a sleeve-like construction within which a portion of the brush handle 74 is positioned. Fixation of the brush is preferably carried out using two clamps. A distinctive feature of this modification is its ability to provide reliable fastening of brushes, including those with a flat handle. The design ensures stable fixation of the brush during the drawing process, which allows the robot artist to create high-quality and varied works.

The technical effect achieved with this brush holder is to provide a stable fixation of brushes (with flat, as well as round or oval cross-section handles) while drawing; an easy exchange of the brushes by detaching the entire assembly from the gripper and attaching another brush clamp assembly to the gripper automatically (using the brush stand) or manually; and a possibility of storing the brush on the brush stand during or outside the painting process.

A further modification of the magnetic brush clamp 30 is shown in FIG. 15, in which the brush holder 76 includes a tilt adjustment mechanism. This modification is intended primarily for attaching wide brushes with relatively thick handles, round or oval in cross section. The advantage of the tilt-adjustable brush clamp is its ability to accurately center and tilt the brush at the desired angle. This embodiment of the brush clamp allows the user to adjust the calibration angle, which, in turn, allows the robot to apply more precise strokes. As shown in FIGS. 15-17, the tilt adjustment mechanism for the attachment of the brush holder 76 to the magnetic base 58, in this embodiment, preferably includes a clamping hood 78, having at least two clamping portions 98, and a tilting yoke 88. Clamping hood 78 is fixedly secured to magnetic base 58 using the two clamping portions 98. Brush holder 76 is fixedly secured within the tilting yoke 88. which is in turn pivotally secured to the two clamping portions 98 so as to allow the tilting yoke 88 with the brush holder 76 to tilt with respect to the base 58, as shown in FIG. 15, for example.

The main functional difference between this modification and the basic magnetic brush clamp described above is the presence of the tilting assembly of the brush holder and the tilting yoke in the adjustable brush clamp. See FIGS. 15-17. It is this tilting assembly that allows the user to more accurately calibrate the brush, which is most conveniently done using the brush calibrator 82, and which is especially important for brushes with a handle that is relatively wide in cross section. As shown in FIGS. 30-31, the brush calibrator includes the target cross-notching 86, where the tip of the brush is to be positioned.

As shown in FIGS. 18-24, while awaiting being used, brushes can be stored in the brash stand 40. The brush stand 40 is specifically designed to be used in conjunction with magnetic brush clamps 30. As shown in FIG. 18, brush stand 40 preferably includes a plurality of compartments 94, each compartment being sized to accommodate one magnetic brush clamp 30 therein. Each compartment 94 includes two side grooves 84, each side grove being configured to slidably receive one side protrusion 64 of the magnetic base 58.

In use, the robotic arm, with a fully assembled magnetic brush clamp attached to the arm's gripper, will move to the brush stand 40 and deposit the magnetic brush clamp into one of the compartments 94 by sliding side protrusions 64 into grooves 84. The robotic arm will then move away from the brush stand, thus separating the magnetic connection between the gripper and the magnetic brush clamp and leaving the magnetic clamp in the stand. The robotic arm can then perform a reverse operation by moving its gripper 20 into a close proximity to another magnetic brush clamp 30 positioned in another compartment 94 of the brush stand 40. Once gripper 20 magnetically attaches to the selected magnetic brush clamp, the robotic arm removes the magnetic brush clamp from its compartment 94 by sliding side protrusions 64 from grooves 84. Thus, side grooves 84 enable an easy detachment and re-attachment of the magnetic brush clamps from/to the gripper. A distinctive feature of the brush stand is its ability to provide automatic brush change without human intervention. This allows the user to automate the drawing process and to make it almost autonomous. The brush stand can also be used as a rack for storing brushes in magnetic brush clamps.

The new effect achieved using the brush stand is the ability to automatically change the brush, which simplifies the drawing process and makes it faster and more effective, as well as the ability to store several brushes installed in brush clamps, which allows the user to paint pictures with several brushes in automatic mode.

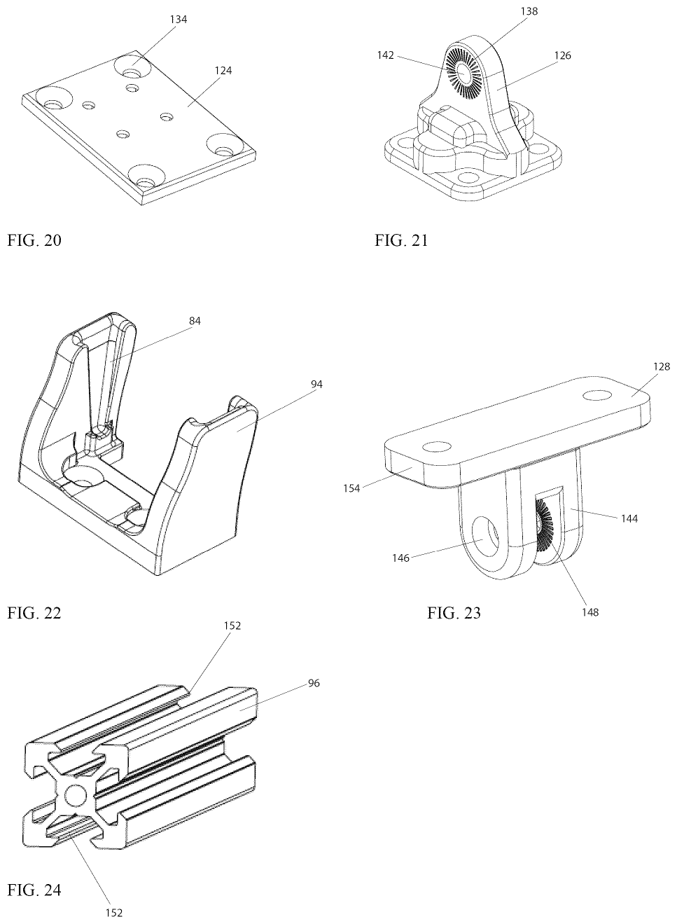

Individual parts of brush stand 40 are shown in more detail in FIGS. 20-24. In accordance with the Figures, brush stand 40 generally includes a rail base 96, a plurality of compartments 94 slidably positioned along the length of the rail base 96, mounting plates 124 securing the brush stand to a selected support surface, intermediate mounting base brackets 126 fixedly connected to the mounting plates, and rail base adapters 128 connecting the rail base to the intermediate mounting base brackets.

Each mounting plate 124 of the brush base stand is used to attach the entire brush stand to a table or another support surface (shelf, easel, etc.) from which it is convenient for the robot to take/place brushes. For the purpose of automatically picking up brushes, each mounting plate 124 is equipped with holes 134 for securely fastening the mounting plate to the support service, preferably with screws. The process of separating the gripper from the magnetic brush clamp, after the magnetic brush clamp is positioned in one of the compartments of the brush stand, requires some effort equal to the force of attraction of the magnets in these kits. Therefore, mounting plates 124 should be securely attached to the supporting surface to withstand this force of attraction/separation without movement of the brush stand.

As shown in FIGS. 21 and 23, each intermediate mounting base bracket 126 includes a ridged positioning dial 138 and a central aperture 142, and each rail base adapter 128 includes two rounded supports 144, each having a through hole 146 and an internal ridged positioning dial 148. Holes 146 and dials 148 are configured to correspond to the central aperture 142 and the positioning dial 138 of the intermediate mounting base bracket 126, so that, when the dials 148 are positioned on the dial 138 at a predetermined angle, and a screw, pin or any other known connector is inserted through the through holes 146 and the aperture 142, the rail base adapter 128, and, consequently, the rail base with all compartments 94, is securely attached to the intermediate mounting base bracket 126 at the optimal desired angle for picking up and returning magnetic brush clamps with the brushes from/to the compartments 94 of the brush stand without the need for additional rotations or other robotic movements. Ridges of the dials 138 and 148 are made to increase adhesion of the intermediate mounting base bracket 126 to the rail base adapter 128. For the convenience of quickly setting the desired angle of the brush stand, the brush stand calibrating angle 112, shown in FIG. 36, can be used. However, manual calibration is also possible.

FIG. 22 shows compartment 94 in more detail. Each compartment 94 is designed for safely storing one magnetic brush clamp 30 with an installed brush 18. Magnetic brush clamps of all modifications can be used with these compartments 94, the design of which ensures simplicity and reliability of picking up and returning brushes by the robot during drawing. The described above complementary design of grooves 84 and protrusions 64, allows for some errors in the movement of the robot when taking and returning the magnetic brush clamps 30 from/to the brush stand 40 notwithstanding any possible forces present during docking and undocking of the gripper 20 from the magnetic brush clamps 30. The brush stand can be scaled up or down to accommodate any desired number of compartments 94. In a typical system, three to ten compartments 94 are utilized.

As shown in FIGS. 23-24, rail base 96 preferably has a plurality of elongated slots 152 extending along the length of each side of the rail base. The profile of the rail base of the brush stand is shown in FIG. 24. This part is preferably made of aluminum. As shown in FIG. 23, the rail base adapter 128 includes a base plate 154, which can be secured to a selected elongated slot 152 of the rail base 96. As shown in FIG. 19, compartments 94 are preferably secured to the elongated slot 152 on the opposite side of the rail base 96. This assembly ensures structural stability of the entire brush stand 40.

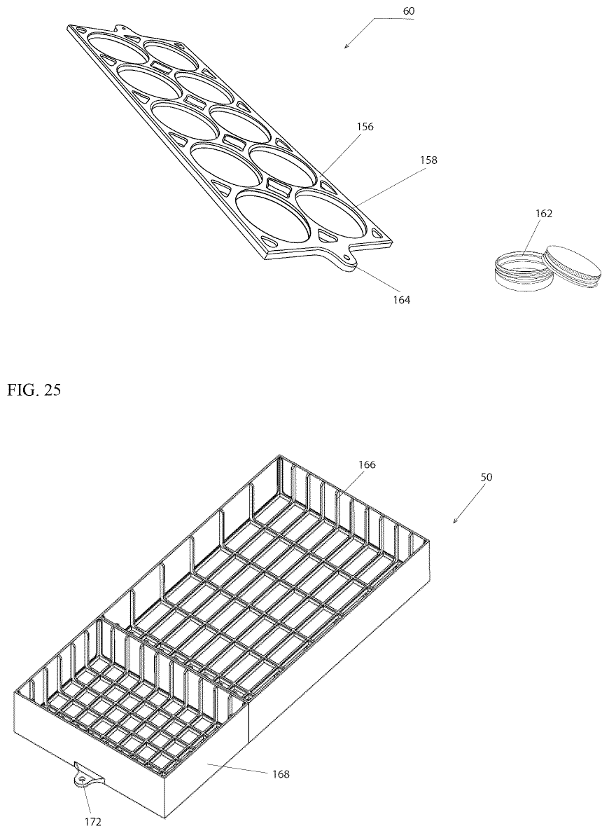

FIG. 25 shows palette 60 in more detail. In the preferred embodiment, palette 60 is an equipment part designed for the convenient and effective use of paints when drawing/painting using the robotic arm 12. Each palette 60 consists of a palette base 156 with a plurality of palette slots 158 and multiple paint jars 162 sized to fit into the palette slots 158. As shown in FIGS. 1-3, the palette 60, with paint jars 162 removably positioned within palette slots 156, is positioned on the supporting surface within the easy reach of the robotic arm 12. One of the distinctive features of the palette 60 is its coordination with the positioning parameters of the gripper-magnetic brush clamp-brush stand of the system, to allow the robotic arm 12 to access the palette within the robot's working area and optimally use the paints of the palette. The jars can be manufactured using 3D printing or purchased as multi-purpose metal jars, preferably having a diameter of 50-52 mm and a volume of 15-50 ml (often used, for example, in the cosmetics industry). Palette base 156 also includes tabs 164 for attaching the palette to the supporting surface, for example, using a screw for secure fixation. When the palette with paint jars 162 removably positioned within palette slots 156 is secured to the supporting surface, the jars are placed directly onto the supporting surface on which the base of the palette is fixed. Palette base 156 then serves to limit possible movement of each jar during the work. Additionally, in order to save materials, cutouts can also be made in the base (“cut-outs” or “voids”) of the stand.

The palette provides simplicity and reliability in use, allows for an easy transportation of paints and is easy to clean. Jars allow the user to store unused leftover paint, providing the optimal amount of paint for the painting process. This simplifies the drawing/painting process and increases the usability of paints.

The technical effect achieved using the palette is to optimize the use of paints when drawing with a robotic arm. Using a palette allows the user to keep its desktop (or any other supporting surface) neat and improve the reliability of the drawing/painting process.

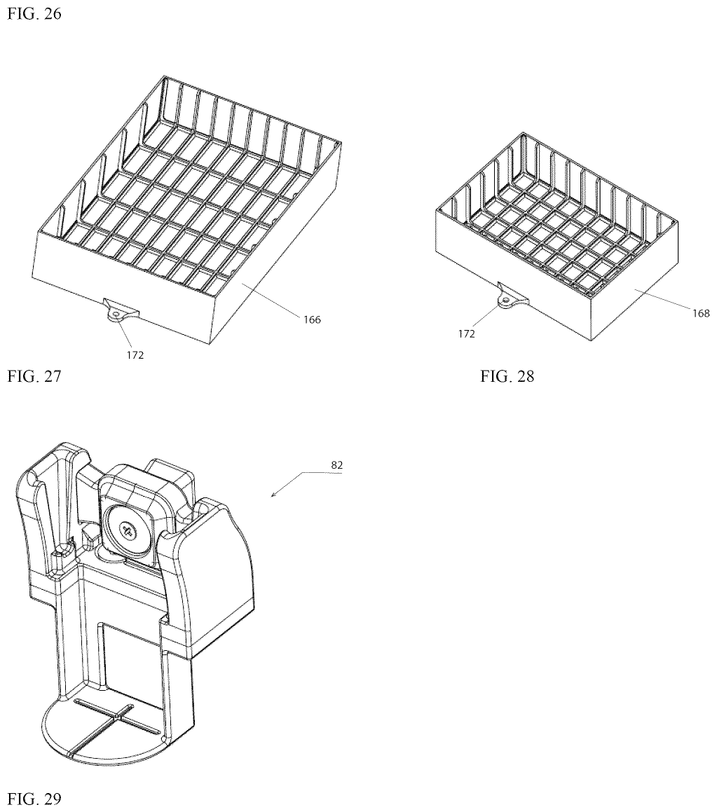

A wiping system 50, illustrated in FIGS. 26-28, is a tool designed to automate the painting process and to ensure efficient cleaning of the paint from an artist's brush when painting with a robot. The wiping system preferably consists of two containers 166 and 168 of different sizes, which are installed on the supporting surface and offer a number of technical advantages.

One of the distinctive features of the wiping system 50 is its ability to be coordinated with the robot's gripper-magnetic brush clamp-brush stand positioning parameters, allowing for an access within the robot's work area and for an optimal use of the entire painting equipment system. The sizes of the containers provide the required quality of brush cleaning.

The wiping system also includes the ability to install standard dishwashing sponges (not shown), a piece of foam rubber or any other highly absorbent material. This allows the user to quickly change contaminated absorbent material, ensuring continuity and the required quality of the drawing process. One of the containers is designed for dipping the brush into solvent or water, depending on the type of paint. Another container is used to remove excess paint from the brush by rubbing it over an absorbent material.

The rubbing system presented in this patent application has a number of technical advantages that provide an improved drawing process and higher quality of work. One of the main technical effects of the wiping system is the automation of the process of cleaning the brush from paint. This allows the robotic artist to continue working quickly and efficiently without the need to mix paints. Thanks to the wiping system, the robot artist can quickly switch between different colors, keeping the designs clean and clear.

Another technical advantage of the rubbing system is the increased accuracy and clarity of patterns. By effectively cleaning the brush of excess paint, the wiping system prevents unwanted color mixing and provides cleaner edges and contours in the robot artist's work.

In addition, the wiping system makes it easy and reliable to use. It is easy to transport and clean, making it easy to use and maintain. This helps improve the productivity and efficiency of the drawing process.

Containers 166 and 168 for wiping are usually installed closely, but can be spaced some distance apart. For greater preservation, they can be reinforced with stiffeners. Each container also preferably includes a tab 172 in the design, with which each container can be fixed to the supporting surface, for example, using a screw (or tape).

In addition to the above-described equipment, the inventive system can be provided with a brush calibrating meter 82, illustrated in FIG. 29. The brush calibrating meter 82 is a device designed for properly installing the artistic brush 18 into the magnetic brush clamp 30 (of any modification) at the required angle and with the required length extension of the brush. It is a calibration equipment that facilitates the brush installation process and allows the user to quickly, easily and exactly calibrate the magnetic brush clamp.

One of the main advantages of the brush calibrating meter is achieving the required accuracy of installation of the brush in the magnetic brush clamp with sufficient ease of use. With this device, the user can quickly and independently calibrate the brush clamp without the need for any practical experience or learning how to install manually, without the use of auxiliary devices. This significantly speeds up the process of preparing for drawing/painting and allows the artist to concentrate on the creative process.

Thus, the brush holder is a solution that provides precision and ease when installing a brush in a magnetic brush clamp. It allows the user to calibrate the brush clamp relatively quickly and accurately, which simplifies the process of preparing for painting.

As shown in FIG. 30-31, brush calibrating meter 82 preferably includes cross-notches 86, the intersection of which provides a target allowing the user to accurately position the brush. The height of the brush calibrating meter 82 is selected to precisely determine the required length of the attachment point for the brush 18 in the magnetic brush clamp 30. To streamline the design and save materials, it may contain a technical cutout.

The inventive system may also include a calibration docking station 174. The calibration docking station is used for precise installation of the magnetic brush clamp, for which it contains grooves for the magnetic brush clamp 30 (on top) and grooves 188 for the calibration dock station clamp (on the side). In use, first, the magnetic brush clamp is installed in its corresponding grooves, then, the calibration dock station clamp is installed in its corresponding grooves. The required reliability of fixation is ensured by the magnets installed in the magnetic brush clamp and a retainer 176 (or a magnet-metal pair). FIG. 33 shows the calibration docking station retainer 176. The calibration dock station retainer preferably includes protrusions 178 for installation into the grooves 188 of the calibration docking station 174, a handle for reverse undocking and a magnet (fixed with a screw (and/or other fastening method). The configuration of its surface facing the magnetic brush clamp ensures the accuracy of the latter's positioning in the brush calibrating meter, as shown in FIG. 30.

The gripper calibration angle 92 is shown in FIG. 34. The gripper calibrations angle is an accessory designed to position the gripper 20 at the desired angle of the brush relative to the robot's drawing plane. The distinctive feature of the gripper calibration angle 92 is its ability to provide accurate gripper installation without the need for manual calibration, which requires hands-on experience. Using the corner for calibrating the gripper, the user can quite easily and conveniently measure the required angle of inclination of the gripper, which allows achieving the desired position of the brush relative to the drawing surface.

The technical effect achieved with the help of the gripper calibration angle is to simplify and speed up the process of installing the gripper at the desired angle. This allows the artist, regardless of his/her experience level, to accurately position the gripper 20 and to ensure the correct brush position for the painting. This approach improves the accuracy and quality of drawing preparation, eliminating the need for more complex manual calibration. FIG. 34 shows a general view of the gripper angle 92, and FIG. 35 shows the gripper angle during the process of calibrating the gripper 20.

The brush stand calibration angle 112, shown in FIGS. 36-37, is an auxiliary device designed to set the brush stand 40 at the desired angle relative to the plane of the supporting surface during the drawing process. The distinctive feature of the brush stand calibration angle 112 is its ability to provide accurate brush stand installation without the need for manual calibration, which requires hands-on experience. Using the angle 112 for calibrating the brush stand, the user can easily, conveniently and expeditiously measure the required angle of inclination of the brush stand, which allows him/her to achieve the required angle of inclination of the brush stand relative to the supporting surface.

The technical effect achieved with the help of the brush stand calibration angle 112 is to simplify and speed up the process of installing the brush stand at the desired angle. This allows the artist, regardless of the experience level, to accurately set the brush stand and to ensure the correct brush position for painting. This approach improves accuracy and quality of work, and also facilitates the creative process by eliminating the need for more complex manual calibration. FIG. 36 shows a front view of the brush stand calibration angle 112; and FIG. 37 sows the brush stand calibration angle during the process of calibrating the brush stand 40.

The magnetic damper 80, shown in FIG. 38, is a device designed to accurately calibrate the positioning of the brush stand 40 relative to the robot. It is an auxiliary equipment that ensures the installation of the brush stand at the required angle and distance with respect to the robot. A distinctive feature of the magnetic damper is its ability to provide precise calibration of the brush stand, which would otherwise require a practical skill. Using the magnetic damper 80, the user can quite easily and accurately set the brush stand in the desired position relative to the robot, without the need for complex and time-consuming manual calibration procedures (in other words, this device “forgives” some operator errors, which is especially important for beginners).

The technical effect achieved with the help of the magnetic damper is to simplify and speed up the process of calibrating the position of the brush stand 40. This allows the artist, regardless of the experience level, to set the brush stand with the required accuracy and to ensure the correct position of the brush for painting.

More specifically, the magnetic damper 80 works to properly convey coordinates of the brushes on the brush stand 40. This is illustrated in more detail in FIGS. 38-41. Magnetic damper 80 preferably includes a damper housing 184 (shown in FIG. 40) and a damper head 186 (shown in FIG. 41) having a magnetic material and being slidably insertable into the damper housing 184. Damper housing 184 includes side protrusions 192, which are configured to be slidably insertable into grooves 84 of the compartments 94 in a manner similar to the one described above. The damper head 186 is used for the actual calibration of the auto-change, that is, the automatic picking up and changing of the brush by the robot from the brush stand. It includes a magnet, fixed with a screw (or other connection method), installed on the reverse side (towards the damper housing). The configuration of its external part ensures compatibility with the gripper configuration to ensure the possibility of their sufficiently accurate docking.

As shown in FIG. 39, the assembled magnetic damper 80 may be removably installed into one of the compartments 94 of the brush stand to calibrate the coordinates of the selected compartment 94 (and consequently of all other compartments 94 and the entire brush stand 40) with the gripper 20 of the robotic arm 12. The damping effect is achieved by selecting the polarity of the magnet installed in the damper head 186, so that the poles of this magnet coincides with the facing pole of the gripper magnet (for example, “+” and “+”), which leads to the repulsion of these parts (within the groove that ensures the damper travel).

Calibration occurs as follows: the robot is controlled by the operator in such a way that the gripper 20 docks (touches) the damper head 186. In this case, as a rule, some operator errors are possible when controlling the robot (for example, pressing the movement button along one of the coordinates for too long, which can lead to too much “pressing” of the gripper and possible malfunction of the robot). The use of this magnetic damper, however, repulses the gripper and allows the user to continue working without any critical consequences.

A brush clip 122 is an auxiliary device designed for long-term storage of a brush 18 installed in a brush clip in a container (for example, a jar) with solvent or oil so that the brush does not touch the walls or bottom of the container and is not deformed. It is a clip that is attachable to the edge of the jar in a way that allows to for the brush to be held in suspension.

A distinctive feature of the brush clip is its ability to keep the brush in working condition for a long time. Thanks to the brush clip, the oil does not harden on the brush, and the tip of the brush does not deform when in contact with the jar. This allows the user to extend the life of the brushes and to keep them in good condition for later use.

The technical effect achieved by using the brush clip is to extend the service life of brushes. The clip prevents the oil from congealing on the brush and prevents the brush tip from becoming deformed, allowing the artists to keep their brushes in optimal condition for painting. This approach increases the cost-effectiveness of using brushes and ensures longer and better use in the creative process.

As shown in FIGS. 42-45, the brush clip 122 preferably includes a fixed gripping portion 194 selectively attachable to the magnetic brush clamp 30 and a pressing lever 196 configured to secure the brush clip to the edge of the jar.

A corner calibrator for computer vision 132, shown in FIGS. 46-47, is a device placed in the corners of a canvas (4 pieces) located on the table. Each calibrator corner has a code tag 198 designed for recognition (such as aruco, QR, etc.), a system of 2-4 corners is used to determine the position of the canvas corners using a camera and computer vision.

A distinctive feature of the corner calibrator is its height, approximately equal to the thickness of the canvas, which allows the camera and computer vision system to see marks from different viewing points without being obstructed by the corners of the canvas.

Installing the corner calibrator at the corners of the canvas allows the computer vision system to more accurately, quickly and easily determine the position of the canvas in space. Corner codes provide unique identification of each corner, allowing the system to determine and track the position of the canvas in real time. This greatly simplifies the process of calibrating a computer vision system, increases the accuracy and reliability of calibration and drawing (protection against accidental canvas shifts), including adjustments during the drawing process.

The outer corner of the calibrator is used for quick and accurate installation to the corner of the canvas; the height is approximately equal to the thickness of the canvas so that the video camera can capture and recognize the mark from any angle. Devices: a corner-calibrator for computer vision (for a horizontally or obliquely lying canvas) and a vertical easel (for a vertically mounted canvas) facilitate the interaction of the robot artist with the canvas, ensuring precise positioning of the canvas relative to the robot, increasing the accuracy and reliability of the work.

Installing a calibrator angle at the corners of the canvas allows the computer vision system to accurately determine the position of the canvas in space. Thanks to the code marks on the corners, the system can accurately determine and track the position of the canvas in real time, allowing the robot artist to work with high precision and repeatability.

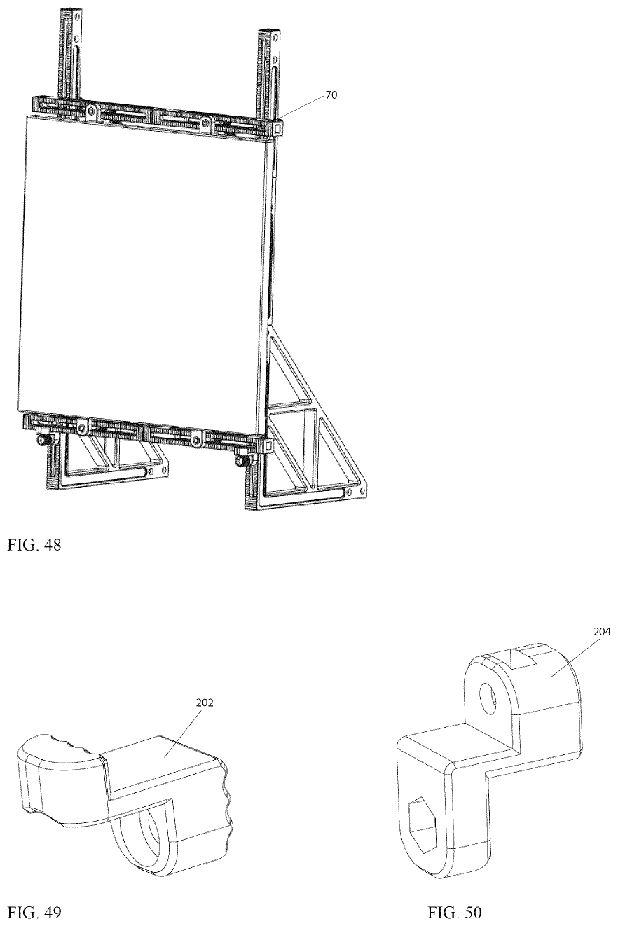

A vertical easel 70, shown in more detail in FIG. 48, provides a comfortable and stable position for the canvas with the ability to adjust its position in the desired direction. This allows the robotic artist to work in optimal conditions, ensuring precision and repeatability in each stroke. All of the above inventory items are characterized by purposeful and functional unity and constructive interdependence. A modular vertical easel is a stand that allows the user to secure a canvas for painting in a vertical position. It takes up little space on the supporting surface and ensures convenient operation of the robot when drawing. A distinctive feature of the modular vertical easel 70 is its compact modular design that allows the user to adjust it to the desired canvas size at the required height with the required accuracy. The design is equipped with adjusting bolts for precise calibration of each of the canvas corners. This provides ease of use and allows the robot artist to work with different sizes and formats of canvases.

The technical effect achieved with a modular vertical easel is to provide the ability to paint on a vertical plane, which is more spectacular, as well as the ability for the robot artist to work with different sizes of canvases.

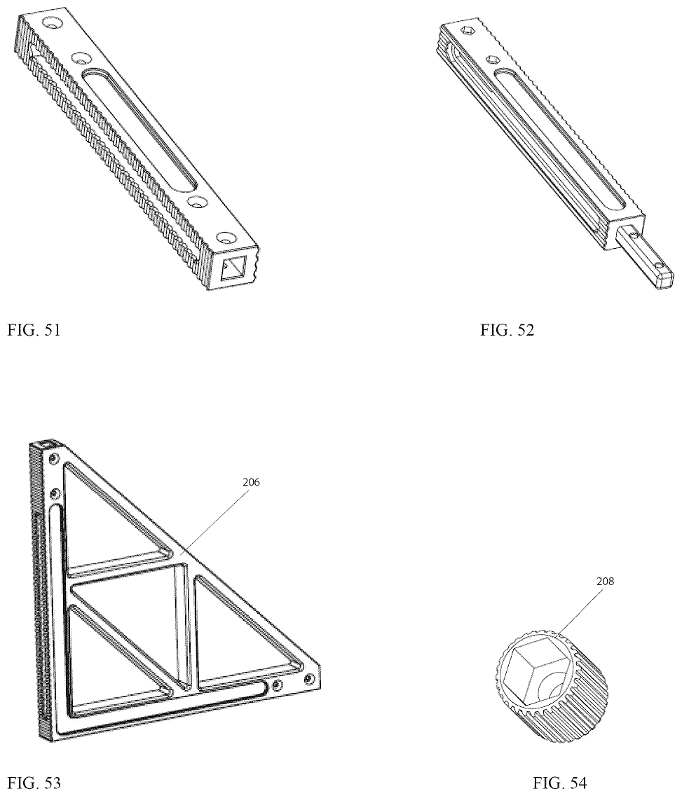

A shown in FIG. 48-50, the modular vertical easel 70 preferably includes a vertical stop 202 and a horizontal stop 204. The vertical stop 202 serves to level and fix the lower shelf for the canvas, which is made up of link part F-F (shown in FIG. 51) and link part M-F (shown in FIG. 52). Two parts of the vertical stop are set at the same height on the attached reference angle 206. This is necessary to accurately calibrate the canvas when drawing.

The horizontal stop 204 serves to more securely fix the canvas between the upper and lower shelves, which are assembled from link part F-F and link part M-F. Link parts F-F and M-F allow the user to assemble an easel of the required length and width, according to the principle of a designer. The F-F link part preferably includes two grooves, and the M-F link part preferably includes a groove and a bushing, which ensures the possibility of their reliable fastening (in addition, there are holes for fixing the fastened links with a screw (or screw). A larger easel can be composed not of two, but, for example, of three links fastened together. To streamline the design and save materials, it may contain cutouts and represent a hollow structure with stiffening ribs.

The supporting reference angle 206 ensures the stability of the easel and ensures that its installation angle is 90 degrees. It may contain cutouts to save materials. It is also equipped with a ribbed surface in part of the movable adjustment zone for more reliable and easier fixation of the vertical stop. Finally, FIG. 54 shows a clamp handle 208 which is configured to fit onto the hexagonal screw (as a removable or stationary part) and serves to conveniently tighten and unscrew the screw. It is designed to ensure that easel calibration does not require the use of tools.

A vertical easel can be used not only for drawing, but also for storing and displaying paintings, including for drawing, storing and displaying paintings created by a person, not a robot. Versatility in terms of paints and brushes used: the set is suitable for working with various types of brushes and paints. Versatility in terms of the robots used: the kit is suitable for working with various types of robots with minimal modifications,

Automation: The kit automates the painting process, including changing and processing brushes, preparing paints and setting up the canvas. Precision: Thanks to the use of the kit, the drawing process becomes more accurate and predictable.

The following positive characteristics of the kit should also be noted: simplicity and low cost of production, simplicity and low cost of operation, ease of transportation and storage, reliability, durability, reliability and maintainability.

After initially attaching the gripper to the robotic hand, it is necessary to adjust its correct position relative to the drawing surface using the gripper calibration angle to ensure the correct position of the hand while drawing. Before painting with a paintbrush and any type of brush clamp (magnetic brush clamp, clamp brush or tilt-adjustable brush clamp), the artist prepares the required number of brushes to create a full-fledged artistic work. For example, an artist takes a brush gauge and a magnetic brush clamp and installs a thin brush with a round cross-section of the handle, then takes a brush gauge and a brush clamp with a clamp and installs a medium brush with a flat cross-section of the handle, and finally repeats the actions with a brush gauge and brush clamp with tilt adjustment for a wide brush with a thick oval cross-section of the handle.

Next, the artist can move on to installing the brush base on the workbench. To ensure simple, quick and accurate installation of the brush stand, several elements of additional equipment are used in the complex: a corner for calibrating the brush base and a magnetic damper for calibrating the brush base. Using an angle, the brush base is set at the desired angle relative to the plane of the desktop, and using a magnetic damper, the exact distance from the brush base to the robot is adjusted.

At the beginning of work, the robot artist selects the desired brush from the brush base using a gripper and any of the types of brush clamps described below. The brush, mounted in the brush clamp, then moves to the wiping system to dip the brush into thinner or water, depending on the type of paint. Next, the robotic arm, coupled with a gripper-brush clamp, is immersed in the desired jar of paint on the palette. After this, the robot artist begins to paint on a canvas mounted on a vertical easel. If it is necessary to change the brush, the process is repeated. The wipe is used to clean the brush of paint during the painting process or just before changing colors.

During breaks in work, the artist can use a brush clip to properly secure the brush mounted in the brush clamp in a jar of solvent or oil or water.

The gripper-brush clamp combination provides optimal tilt and reliability of the brush during drawing, which allows the user to obtain the required accuracy while drawing.

The gripper-brush-clamp-palette combination provides the ability to automatically pick up the desired paint colors while painting, which simplifies the painting process for the artist.

The gripper-brush clamp-wipe system combination provides the ability to automatically clean the brush from excess paint, which allows the robot artist to quickly and efficiently continue working without the need to manually clean the brush while painting, maintaining the purity of colors.

The gripper-brush clamp-brush base combination provides the ability to automatically change brushes while painting, as well as convenient storage of brushes in the brush clamps.

The invention can be implemented using various materials and technologies. For small production runs, the most optimal option would be to use 3D printing. This allows the necessary components to be produced quickly and inexpensively, and design changes can be easily made if necessary.

As production volumes increase, the user can move to more traditional manufacturing methods such as casting or stamping. This will reduce the cost of production due to scale. Depending on strength and durability requirements, components can be made from a variety of materials, including various types of plastic, metal, or composites.

The invention may be modified and improved by adding new components, improving the functionality of existing components, and by integrating with other systems and devices. For example, the user can add a function for automatically replacing brushes, improve the brush attachment system, add a function for automatically preparing paints, etc.

1. A system of equipment for creating artworks using a robot artist having a robotic arm, said system comprising:
a gripper removably installed in said robotic arm, the gripper comprising a first magnetic material;
a magnetic brush clamp configured to support a painting brush, the magnetic brush clamp comprising a second magnetic material selected to removably attract to the first magnetic material of the gripper so as to removably attach said magnetic brush clamp with the painting brush to said gripper; and
a brush stand comprising a plurality of compartments, each compartment being sized and configured to removably receive said magnetic brush clamp with the painting brush therein,
wherein relative positions and inclination angles between said gripper, said magnetic brush clamp and said brush stand are calibrated for optimal painting conditions for said robot artist.

2. The system of equipment according to claim 1, wherein said gripper further comprises a bracket assembly having a base, an intermediate bracket and a brush clamp adapter, wherein said base is configured to fixedly attach the entire bracket assembly to the robotic arm, wherein said intermediate bracket is configured to position said brush clamp adapter at a desired inclination angle, said desired inclination angle being an angle optimal for tilting the painting brush for applying strokes in a selected artistic style, and wherein said brush clamp adapter is designed with an ability to rotate relative to said intermediate bracket so as to change said inclination angle thus changing an angle of inclination of the brush.

3. The system of equipment according to claim 2, wherein said brush clamp adapter of said gripper includes an outer wall surrounding said first magnetic material, wherein the magnetic brush clamp comprises a magnetic base with a recess, wherein said second magnetic material is positioned within said recess of said magnetic base, wherein said recess includes an inner wall, and wherein said outer wall of said brush clamp adapter and said inner wall of said recess are shaped to be complementary to each other so as to form a tight connection when said first magnetic material is attracted to said second magnetic material.

4. The system of equipment according to claim 1, wherein said magnetic brush clamp comprises a magnetic base having at least one side protrusion, wherein each of said compartments of said brush stand comprises at least one side groove, said side groove being shaped to slidably receive said side protrusion of said magnetic base therein.

5. The system of equipment according to claim 1, wherein said magnetic brush clamp further comprises a brush bracket configured to retain said painting brush within said magnetic brush clamp, said brush bracket having a brush recess sized to accommodate a portion of a handle of said painting brush along its length.

6. The system of equipment according to claim 1, wherein said magnetic brush clamp further comprises a tilting brush holder configured to retain said painting brush within said magnetic brush clamp, said tilting brush holder being configured to selectively tilt with respect to the rest of the magnetic brush clamp so as to incline said painting brush with respect to the robotic arm.

7. The system of equipment according to claim 1, further comprising a painting surface on which said robot artist creates said artwork using said painting brush.

8. The system of equipment according to claim 7, wherein said painting surface is installed on a vertical easel.

9. The system of equipment according to claim 7, wherein said painting surface is installed horizontally.

10. The system of equipment according to claim 1, further comprising a painting palette, each painting palette comprising a plurality of paints for dipping said painting brush into.

11. The system of equipment according to claim 10, further comprising a brush wiping system configured to wipe off paints from said painting brush.

12. The system of equipment according to claim 1, further comprising a brush calibrating meter configured to assist in installation of said painting brush into said magnetic brush clamp.

13. The system of equipment according to claim 1, further comprising a magnetic damper configured to be removably and selectively installed into one of said compartments of the brush stand to calibrate a relative position of said brush stand with respect to said gripper and said robotic arm.
